(19) United States
(12) Patent Application Publication
(10) Pub. No.: US 2014/0096078 A1
(43) Pub. Date: Apr. 3, 2014

(54) Diagnostic Systems And Methods For Visualizing And Analyzing Factors Contributing To Skin Conditions

(71) Applicant: Nicholas Prior, Wilton, CT (US)

(72) Inventor: Nicholas Prior, Wilton, CT (US)

(21) Appl. No.: 13/633,233

(22) Filed: Oct. 2, 2012

(51) Int. Cl. G06F 3/048

(52) U.S. Cl. 715/810

(57) ABSTRACT

Diagnostic systems and methods for visualizing and analyzing factors contributing to a health and/or wellness concern of a specific subject are provided. The systems and methods employ a set of multiple choice questions and a graphical representation of graphical elements corresponding to the subject's responses, the graphical representation permitting a user of the diagnostic systems and methods to utilize the relative positioning of graphical elements on the graphical representation to draw inferences relative to the health and/or wellness concern of the subject.

### FIELD OF THE INVENTION

The present invention relates to diagnostic systems and methods, and, in particular, to systems and methods for visualizing and analyzing factors contributing to the skin condition of a specific consumer.

### BACKGROUND OF THE INVENTION

Skin care products and treatment regimens have typically been mass-marketed to all consumers. A major challenge to the beauty industry has been to implement customized service and treatment approaches. Until now, customized skin analysis and skin care have principally consisted of skin-typing or determining the skin composition or category of an individual's skin. One form of skin-typing utilizes the Fitzpatrick scale, which was developed by a dermatologist as way to classify the response of different types of skin to ultraviolet (UV) light (i.e., ease of burning and/or tanning), and is still recognized as a dermatological research tool. In the cosmetics arena, a more common form of skin-typing classifies skin into six basic groups: normal, oily, dry, combination, sensitive and aging. Normal skin is generally defined as elastic, with medium sized pores, a clean and smooth texture, and good circulation. If skin is dry, it typically will feel tight and may be flaky, may look sallow, and will be prone to developing wrinkles. Oily skin looks greasy, particularly on the forehead, nose and chin (the “T” zone), has enlarged pores and is prone to acne. Combination skin presents as patches of both dry and oily skin; the dry zones appearing around the eyes and on the cheeks, while oily areas are seen in the T zone. Sensitive skin is typically extremely dry and tight, and tends to become irritated easily. This type of skin is thin and delicate with small pores, but may develop reddish and scaly areas, can be itchy or tingly, and is prone to spotty acne breakouts. Aging or sun-damaged skin feels tight and has visible wrinkling. Areas of hyperpigmentation may be present. The skin is slack, particularly around the cheeks and jaw line, and may even have a leathery texture. The presence of broken capillaries in such skin is common.

Usually, once a beauty consultant at a cosmetic counter classifies the skin type of a customer, the products and/or regimens advocated for use are the same products and/or regimens recommended to all customers having that particular skin type. For example, if the classification is oily skin, the customer may be advised to cleanse with a product recommended specifically for oily skin, to exfoliate several times per week with a gentle product, and to use an oil-free moisturizer. An astringent also may be recommended. As to cosmetic products, oil-free foundations and powder forms of bronzer and blusher are advised.

Thus, although many skin care and/or cosmetic companies have developed products specifically designed for oily skin, or dry skin, or sensitive skin, and so forth, every customer in a particular skin class receives the same beauty advice and product recommendations. However, even within a particular category, all skins are not alike. There is therefore still a need for a more highly customized service experience which permits the beauty consultant to see customers as individuals rather than simply as members of a skin classification subdivision, and to educate the customer and offer her advice which is tailored to her specific concerns and needs, thus reaching beyond merely recommending cosmetic product(s) or a product regimen.

### SUMMARY OF THE INVENTION

The present invention, in one aspect, provides a diagnostic system comprising:
a set of multiple choice questions, wherein each multiple choice question has:
   a category assigned thereto;
   a predetermined relative importance assigned thereto;
   a selection of possible responses associated therewith, each possible response having a predetermined relative importance assigned thereto; and
a graphical representation comprising a set of graphical elements drawn on a segmented plane, each graphical element corresponding to a subject's response and comprising:
   a graphical indication of the category of question;
   a graphical indication of the relative importance of each question;
   a graphical indication of the relative importance of each response of the subject; and
   a graphical indication of the relevance of each response of the subject according to a predetermined model of health and/or wellness; said graphical representation permitting a user of the diagnostic system to utilize the relative positioning of at least one graphical element on the graphical representation to draw at least one inference relative to a health and/or wellness concern of the subject.

In another aspect, the present invention provides a method of evaluating a health and/or wellness concern of a subject comprising:
(a) providing a set of multiple choice questions, wherein each multiple choice question has:
   a category assigned thereto;
   a predetermined relative importance assigned thereto;
   a selection of possible responses associated therewith, each possible response having a predetermined relative importance assigned thereto;
(b) recording the responses of the subject to the set of multiple choice questions;
(c) generating a graphical representation of the responses of the subject, the graphical representation comprising a set of graphical elements drawn on a segmented plane, each graphical element corresponding to the subject's response and comprising:
   a graphical indication of the category of question;
   a graphical indication of the relative importance of each question;
   a graphical indication of the relative importance of each response of the subject; and
   a graphical indication of the relevance of each response of the subject according to a predetermined model of health and/or wellness; and
(d) determining the context of one or more of the responses based on the relative positioning of the response on the graphical representation.

### BRIEF DESCRIPTION OF DRAWINGS

FIG. 1 is an illustration of a map generated in accordance with the present invention.

FIG. 2 is an illustration of a portion of the map shown in FIG. 1.

### DETAILED DESCRIPTION OF THE PREFERRED EMBODIMENTS OF THE INVENTION

The present invention advances the concept of a diagnostic tool which traditionally is based on a single mathematical formula or algorithm which takes in a set of weighted criteria (i.e., weighted factors are used to define the level of importance of various criteria) and returns a result or diagnosis. As an example, a diagnosis as to skin composition typically assigns a subject to one of a small, fixed number of categories, typically three to five, e.g., oily, dry, sensitive, etc., which in turn leads a beauty consultant to recommend a product or product regimen adapted for that particular category of skin. Existing methodologies for typing skin therefore have one prescribed method for dealing with all consumers within a single skin type category.

On the other hand, a principle advantage of the present invention is that a trained beauty consultant may look at the information collected from any number of consumers within the same skin type category and see them as uniquely different, which allows for improvement in service level and customization of treatment for each consumer. The present invention therefore provides opportunities to the beauty consultant and the consumer which extend well beyond those provided by known diagnostic models which assign an individual to a general category and treat all members of a category substantially identically.

According to a first aspect of the present invention, a diagnostic system is provided, the system comprising:
a set of multiple choice questions, wherein each multiple choice question has:
   a category assigned thereto;
   a predetermined relative importance assigned thereto;
   a selection of possible responses associated therewith, each possible response having a predetermined relative importance assigned thereto; and
a graphical representation comprising a set of graphical elements drawn on a segmented plane, each graphical element corresponding to a subject's response and comprising:
   a graphical indication of the category of question;
   a graphical indication of the relative importance of each question;
   a graphical indication of the relative importance of each response of the subject; and
   a graphical indication of the relevance of each response of the subject according to a predetermined model of health and/or wellness; said graphical representation permitting a user of the diagnostic system to utilize the relative positioning of at least one graphical element on the graphical representation to draw at least one inference relative to a health and/or wellness concern of the subject.

The graphical representation, the category of question, the relative importance of each question, the relative importance of each response of the subject, and the relevance of each response according a predetermined model of health and/or wellness represented on the graphical representation, may be indicated in any known manner for creating graphical representations by employing any graphical symbols useful in creating a graphical representation. For example, graphical representation comprising a set of graphical elements drawn on a segmented plane may be illustrated as a set of points arranged on a radial map. The category of question may be shown by a predetermined pattern of shading associated with each point. The graphical indication of the relative importance of each question may be a radial line segment of predetermined length associated with each point. The relative importance of each response may be indicated by the point having a diameter of predetermined length. The graphical indication of the relevance of each response of the subject according to the predetermined model of health and/or wellness may be represented by the location of the point within one segment of the segmented plane. If desired, the subject's age may also be represented, for example, by a series of concentric circles on the radial map, where the number of concentric circles represents a bucketed age classification.

The graphical representation permits the user of the systems of the invention to utilize the relative positioning of at least one graphical element corresponding to at least one or the subject's responses in relation to at least one other graphical element corresponding to at least one other of the subject's responses on the graphical representation to draw at least one inference relative to a health and/or wellness concern of the subject. The graphical representation also permits the user to recognize at least one subgroup of at least two graphical elements corresponding to at least two of the subject's responses and to analyze the at least two of the subject's responses in the context of a health and/or wellness concern of the subject.

The systems of the present invention therefore enable the beauty consultant to deconstruct questions and responses based on a set of criteria, mapping responses as data points, and thus create a visual representation of an individual's characteristics (i.e., a “footprint”) based on that set of criteria. The visual representation or map is an interactive navigation system providing a framework for identifying connections between an individual respondent's characteristics and concerns, as well as educating the consumer with information that is specific to her concerns and needs. A multitude of inferences may be made concerning the overall picture of a subject by analyzing the relationships between the mapped data points, whether within a cluster of points (i.e., subgroup) or among clusters of points. Thus, when a single response is contextualized, it becomes clearer that many factors may contribute to it. The beauty consultant is therefore able to utilize the map to see and service the consumer in a unique fashion rather than assigning a consumer to one of a few classes or buckets. The present invention permits the trained beauty consultant to visually (1) recognize differences in types of categories of questions being factored into the analysis; (2) understand the importance of each question being asked; (3) understand the meaning of each response given; and (4) utilize the relative positioning of any data point on the map to create an essentially unlimited number of inferences about the individual. Thus, prior to the present invention, a consumer's responses were relevant only in the aggregate, while now, new and relevant meaning may be inferred by looking at responses individually, in sub-groupings, and through the contextualization of other responses.

The systems of the present invention are preferably adapted for use with software for display on a PC, or as an app for a handheld or mobile device, such as a Smartphone or a tablet, and the like.

Computer-based systems may utilize a workstation, a personal computer, and the like. The computer preferably contains a data entry module, such as a keyboard or a touch-screen, to allow direct entry of a data set of a subject's responses to a set of multiple choice questions, for example, a subject's biological and/or psychological information, by the subject or by a trained consultant. The data entry module may also be a direct connection (such as USB, Firewire, or other interface) or a network connection (such as modem or other network connections) for transmitting and receiving use-related biological and/or psychological data, for example, via a portable medium such as a compact disk (CD) or a digital versatile disk (DVD) or via the internet.

The computer further contains a data processing module, such as a central processing unit (CPU), which is in communication with the data entry module. The data processing module is configured for applying a software program to the above-described data set entered through the data entry module. The data processing module is more specifically under the control of a computer-readable medium containing coded instructions for processing the data set.

The program (or application) may be implemented in any programming language that is suitable for the platform (e.g., computer-based system) on which the program runs. The platform may be in the context of handheld and mobile devices (i.e. personal digital assistants, mp3 players, mobile phones, portable videogame consoles, digital cameras, GPS devices), laptop and desktop computers, digital kiosk displays, cable or satellite television, television gaming consoles, and so forth.

The program may be run in a distributed computing environment, such as a local area network or the internet, or in a non-distributed environment, such as a stand-alone kiosk. In general, the program application may be implemented in a compiled or interpreted programming language, with or without the generation of object code. Preferably, the program is implemented in a programming language that supports touch screen input, and screen and printer output. The program proper may make use of control flow statements, such as selection and loop; branching structures, such as conditional and/or unconditional redirects, subroutines and termination; and interrupt algorithms, such as error handling. Various programming paradigms may be useful in implementing a program useful according to the present invention, however, an event driven programming approach may be preferred, in which user input triggers one or more event-handlers. Other potentially useful paradigms include object oriented, structured, imperative and functional.

Many known programming languages may be useful to implement one or more portions of the application. Particularly useful may be ActionScript, Objective-C, Java, JavaScript, PHP/MySQL, and the Microsoft.NET family of languages. Markup languages such as HTML, XML, XHTML and others may also be useful in deployment of the application. In one embodiment of the present invention, an application is implemented in ActionScript 3 and XML (Example 2, herein).

The computer further contains an output or displaying module in communication with the data processing module for displaying the result, i.e., the graphical representation, for example, in the form of a map. The output or displaying module may include the computer display screen for visually displaying the result, or a printer for printing the result, or a network connection for outputting the result to a remote location.

The computer has a memory module for storing information, such as educational materials in the form of, for example, text, images, and videos, which explain the significance of each question and the meaning behind an individual's response to that question. Additionally, the memory module may include information about various treatment products and/or lifestyle changes, which are suitable for, and may be recommended to, the individual.

In accordance with a second aspect of the present invention, a method of evaluating a health and/or wellness concern of a subject is provided, the method comprising:
(a) providing a set of multiple choice questions, wherein each multiple choice question has:
   a category assigned thereto;
   a predetermined relative importance assigned thereto;
   a selection of possible responses associated therewith, each possible response having a predetermined relative importance assigned thereto;
(b) recording the responses of the subject to the set of multiple choice questions;
(c) generating a graphical representation of the responses of the subject, the graphical representation comprising a set of graphical elements drawn on a segmented plane, each graphical element corresponding to the subject's response and comprising:
   a graphical indication of the category of question;
   a graphical indication of the relative importance of each question;
   a graphical indication of the relative importance of each response of the subject; and
   a graphical indication of the relevance of each response of the subject according to a predetermined model of health and/or wellness; and
(d) determining the context of one or more of the responses based on the relative positioning of the response on the graphical representation.

The graphical representation, the category of question, the relative importance of each question, the relative importance of each response of the subject, and the relevance of each response according a predetermined model of health and/or wellness represented on the graphical representation, may be indicated in any known manner for creating graphical representations by employing any graphical symbols useful in creating a graphical representation. For example, graphical representation comprising a set of graphical elements drawn on a segmented plane may be illustrated as a set of points arranged on a radial map. The category of question may be shown by a predetermined pattern of shading associated with each point. The graphical indication of the relative importance of each question may be a radial line segment of predetermined length associated with each point. The relative importance of each response may be indicated by the point having a diameter of predetermined length. The graphical indication of the relevance of each response of the subject according to the predetermined model of health and/or wellness may be represented by the location of the point within one segment of the segmented plane. If desired, the subject's age may also be represented, for example, by a series of concentric circles on the radial map, where the number of concentric circles represents a bucketed age classification.

The graphical representation permits the user of the systems of the invention to utilize the relative positioning of at least one graphical element corresponding to at least one or the subject's responses in relation to at least one other graphical element corresponding to at least one other of the subject's responses on the graphical representation to draw at least one inference relative to a health and/or wellness concern of the subject. The graphical representation also permits the user to recognize at least one subgroup of at least two graphical elements corresponding to at least two of the subject's responses and to analyze the at least two of the subject's responses in the context of a health and/or wellness concern of the subject.

The method enables the user to utilize the relative positioning of at least one graphical element in relation to at least one other graphical element on the graphical representation to draw at least one inference relative to a health and/or wellness concern of the subject.

The method further enables the user to recognize at least one subgroup of at least two graphical elements corresponding to at least two of the subject's responses and to analyze the at least two of the subject's responses in the context of a health and/or wellness concern of the subject.

The methods of the present invention are preferably adapted for use with software for display on a PC, or as an app for a handheld or mobile device, such as a Smartphone or a tablet, and the like. However, those skilled in the art would appreciate that the present invention also may be carried out manually. Therefore, manual calculation and drawing, based on a subject's responses, could be used to achieve the same results, and the consultant may then recognize the subgroups in the drawing and utilize a manual, for example, to access educational information, contextual advice, recommendations related to products and/or lifestyle changes, and so forth tailored to the health and/or wellness concern of a subject.

Therefore, in accordance with a preferred embodiment of the invention, the computer-aided method comprises providing the multiple choice questions and possible responses in the form of a software program, and enabling the subject to select a response to each question, wherein coded instructions for processing data are applied to the responses of the subject, and the graphical representation of the subject's responses is displayed on a screen or printer or output to a remote location.

The software program preferably includes stored educational information in the form of text, images, and/or videos, and the graphical representation generated by the software program comprises a map having a number associated with each response. The subject or a consultant may tap or click on any number on the map to access the educational information related to enlighten the user as to the relative importance of the multiple choice questions and the subject's answers to a health and/or wellness concern of the subject.

The software program may also include stored information related to products and/or treatment regimens and enable the user to tap or click on the graphical representation to access the information related to products and/or treatment regimens targeted to the subject based on the relative positioning of the subject's responses on the graphical representation.

A specific example of a computer-aided method according to the invention is described below in the context of the Eastern philosophy of Traditional Chinese Medicine (TCM). The method, modeled on TCM, utilizes information collected in accordance with TCM principles, with categories of multiple choice questions including skin and skin care, body constitution, and lifestyle. In this example, the set of multiple choice questions is related to a skin condition of a subject, the skin conditions including lack of radiance, dryness, oiliness, redness, acne, excessive pigmentation, uneven skin tone, wrinkles, sagging and sensitivity.

TCM takes a holistic view of human health, and teaches that an internal physiological balance must be maintained for an individual to be in good health, and that all disease is caused by imbalances manifesting through an identifiable pattern of symptoms and requires a particular set of treatments for correction. As one specific example, a subject may visit the TCM practitioner with concerns related to her skin, such as a lack of skin radiance. The TCM practitioner examines the body using noninvasive techniques, including observing physiological characteristics, and poses questions of the individual related to health and lifestyle. The TCM diagnosis rendered is indicative of the relative or Yin-Yang balance of the individual. The diagnosis may include, but is not limited to, one of three categories, including Yang-dominant, Balanced, and Yin-dominant, or one of five categories, including Yang-dominant, Balanced-to-Yang, Balanced, Balanced-to-Yin and Yin-dominant, and so forth. Yang-dominant characteristics may include reddish, oily and reactive/acne prone or easily inflamed skin, and a general sensitivity to heat. Yin-dominant traits may be pale skin tone and dry, easily desquamated skin with a tendency toward development of pigmentation and pre-mature wrinkling, and a sensitivity to cold. Balanced or normal skin, in contrast, is not too oily or too dry and has a radiant, smooth, clean appearance with good elasticity and even skin tone that reflects overall good health. After rendering a diagnosis of the subject's condition, the TCM practitioner typically prescribes a blend of herbal ingredients and optionally, lifestyle changes, to re-establish internal physiological balance and therefore good overall health.

In modeling the diagnosis of an experienced TCM practitioner, biological and/or psychological information of the type which may be useful in assisting the TCM practitioner in determining the subject's unique skin composition footprint is collected from a subject. The term “biological information” may include physiological data that represents distinctive features or characteristics of an individual, including, but not limited to, age, cheek color, skin condition and complexion, and level of physical fitness, associated with a particular skin composition. The term “psychological information may include, but is not limited to, stress level, energy level, and emotional wellness of an individual. Some of the information may be collected by asking the individual to conduct a self-evaluation, recording responses on a questionnaire. The questionnaire may be completed at a retail location, online, or on a handheld device, and so forth. Some questions on the questionnaire may relate to clinical symptoms of the type taken into consideration by a TCM practitioner when examining a patient, such as whether the individual experiences sweaty palms, the tendency to feel thirsty or tired, or to become overheated, and the like. Other questions may be related to observable physiological symptoms such as the overall appearance of the skin complexion. Further questions may include those relevant to a particular skin concern of the individual, such as dryness, redness, acne, excessive pigmentation, wrinkles, and so forth. Still other questions may relate to the individual's lifestyle, such as sleep pattern, dietary habits, physical fitness, stress level, and the like. Upon completion of the questionnaire by the individual, the responses to questions are quantified or converted into numerical values for future processing, whether manually, by computer-aided methods or a using a combination of these methods. Optionally, some information may also be collected by a trained consultant who examines the individual and evaluates characteristics of the individual according to photo-grading (0-10) scales, so as to improve the objectivity and accuracy of the evaluation. This evaluation may be carried out on-site at a retail location or remotely through interactive consultation with the specific user via the internet (e.g., by using certain widely available instant messaging application software with video-conferencing capacity, such as iChat or Skype). Further, some information may be collected by using an electronic device that takes certain measurements on the individual, such as imaging devices that can be used to quantitatively measure coloration of certain parts of the user's body such as the overall complexion; medical devices to measure, for example, blood circulation/oxygenation. As examples of some devices which may be used to collect information, mention may be made of a Corneometer® CM 825, measuring skin surface hydration; a Sebumeter® SM 815, measuring sebum on the skin surface; a Cutometer®, measuring skin elasticity; a Skin-pH-Meter® PH 905; a Mexameter® MX 18, measuring melanin and/or erythema; a Skin-Thermometer® ST 500, measuring skin temperature; a Tewameter® ST 500; a Colorimeter CL 400, measuring redness; and a Glossymeter GL 490, measuring radiance/dullness, all of which are available from Courage+Khazaka Electronic GmbH, Germany. These results, too, would be converted into numerical values and used together with other collected information (collectively, “information”) for future processing, whether manually or by computer-aided methods.

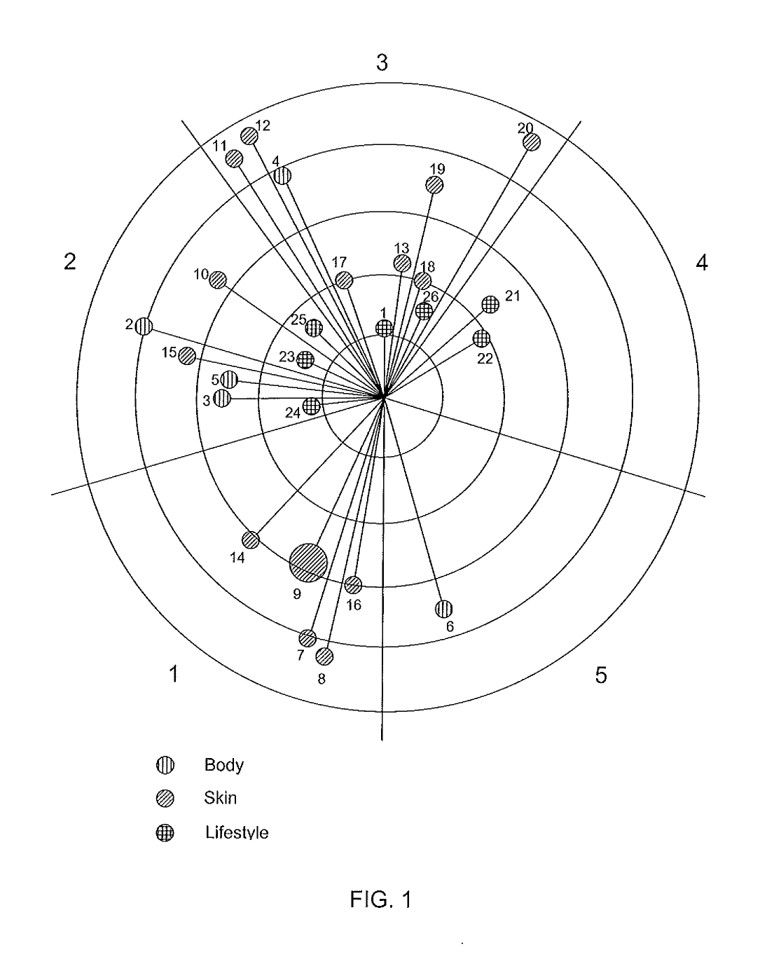

As described below, information is obtained through a subject's self-evaluation as prompted by a questionnaire containing various questions related to a few general categories or factors including age, body, skin, and lifestyle. The information (i.e., responses to questions) collected about the subject is converted to numerical values, and visualized on a radial map having a configuration of the type illustrated in FIG. 1. The map consists of a circle which is divided into five equal segments. Data points, each of which corresponds to a subject's response to a question posed in the questionnaire, are plotted onto the radial map. The points are plotted based on five key differentiators which provide the mapping logic:

A. Question-specific differentiators (shown below in Table 1) are pre-determined criteria which do not change from subject to subject regardless of the answer to the question, and are the following:

1. The shading (e.g., color or hash marking) of the point. This differentiator is used to classify the question as to type. The questionnaire includes different types of questions:

a. questions related to body constitution, based on TCM (Shading 1)

b. questions related to skin and skincare (Shading 2)

c. questions related to lifestyle (Shading 3)

2. The length of the line connecting the point to the center of the map. This differentiator is used to indicate a ranking of the importance of a question on the basis of a Western skin care scale. In this example, the diagnostic questionnaire contains 26 questions. Shorter line lengths denote questions of lesser importance while longer line length is indicative of questions of greater importance. The length of the lines increases according to the following pattern: 1y, 2y, 3y . . . 26y, where y is a fixed unit of length.

B. Answer-specific differentiators (shown below in Table 2) are related specifically to the answer related by the subject, and are the following:

3. The positioning of the points within the five radial axis segments. This differentiator is used to designate the relevance of the response according to TCM principles as follows:

a. Segment 1 (0 to 72 degrees)—Yin-dominant body/skin constitution

b. Segment 2 (72 to 144 degrees)—Balanced-to-Yin body/skin constitution

c. Segment 3 (144 to 216 degrees)—Balanced body/skin constitution

d. Segment 4 (216 to 288 degrees)—Balanced-to-Yang body/skin constitution

e. Segment 5 (288 to 360 degrees)—Yang-dominant body/skin constitution

The bottom of the circle on the radial map (i.e., corresponding to the “6” on the face of a clock) is the starting point, or 0 (or 360) degrees of the radial map. The segments then proceed in a clockwise direction, each segment occupying 72 degrees. The top of the circle (i.e., corresponding to the “12” on the face of a clock) corresponds to the center of the third segment, representing a “Balanced” constitution based on the principles of TCM.

4. The point diameter. This differentiator is used to indicate the importance of the response type, based on Eastern TCM principles. The present invention utilizes one of three diameters for each question or point, with the following meanings, where “x” indicates a fixed unit of length:

a. question of Lesser Importance (diameter x)

b. question of Moderate Importance (diameter 2x)

c. question of Higher Importance (diameter 3x)

5. Concentric circles around the center of the circle. This differentiator is used to indicate a respondent's bucketed age segmentation, according to the following classifications:

a. less than 19 years—5 concentric circles

b. 20-29 years—10 concentric circles

c. 30-39 years—15 concentric circles

d. 40-49 years—20 concentric circles

e. 50-59 years—25 concentric circles

f. More than 60 years—30 concentric circles

At the same biological age, two different subjects may have dramatically different skin textures often due to lifestyle choices that impact the condition of the skin.

TABLE 1
Question-specific differentiators

| Num- | | Point | Line |
|---|---|---|---|
| ber | Question | Color | Length |
| 1 | What is your age? | Color 3 | 1 |
| 2 | What do you fear? | Color 1 | 22 |
| 3 | What characteristic best describes you? | Color 1 | 12 |
| 4 | Do you often have sweaty palms? | Color 1 | 20 |
| 5 | What flavors do you prefer? | Color 1 | 11 |
| 6 | Do you have night sweats while sleeping? | Color 1 | 19 |
| 7 | What is the color of your cheeks? | Color 2 | 21 |
| 8 | Skin color variant scale | Color 2 | 23 |
| 9 | How would you describe your overall facial | Color 2 | 13 |
| | complexion? | | |
| 10 | Dull-Radiance scale | Color 2 | 17 |
| 11 | Do you have facial blemishes? | Color 2 | 24 |
| 12 | Acne breakout scale | Color 2 | 26 |
| 13 | How frequently do you usually experience | Color 2 | 9 |
| | facial blemishes, if at all? | | |
| 14 | What is your skin condition? | Color 2 | 15 |
| 15 | Dry/Moist/Oily scale | Color 2 | 16 |
| 16 | Do you have severely dry facial skin? | Color 2 | 14 |
| 17 | Do you have facial pigmentation issues? | Color 2 | 7 |
| 18 | Skin Tone scale | Color 2 | 8 |
| 19 | Do you have dark spots on your face? | Color 2 | 18 |
| 20 | Age/Dark Spots scale | Color 2 | 25 |
| 21 | If you have difficulty staying asleep, for what | Color 3 | 10 |
| | reason is your sleep disturbed? | | |
| 22 | Do you have difficulty falling asleep? | Color 3 | 6 |
| 23 | How many times a week do you exercise? | Color 3 | 3 |
| 24 | How frequently do you take vitamin | Color 3 | 2 |
| | supplements? | | |
| 25 | Which of the following best describes your | Color 3 | 5 |
| | typical meal? | | |
| 26 | How would you rate your emotional | Color 3 | 4 |
| | well-being? | | |

TABLE 2
Answer-Specific Differentiators

| | | | | Concentric Circles | |
|---|---|---|---|---|---|
| Question | | Responses | | (first question only) | |
| 1a | What is your | A | Less than 19 | 5 concentric circles | |
| | age? | B | 20-29 | 10 concentric circles | |
| | | C | 30-39 | 15 concentric circles | |
| | | D | 40-49 | 20 concentric circles | |
| | | E | 50-59 | 25 concentric circles | |
| | | F | More than 60 | 30 concentric circles | |
| | | | | Radial | Point |
| Question | | Responses | | Axis Segment | Diameter |
| 1b | What is your | A | Less than 19 | 3 | 1 |
| | age? | B | 20-29 | 3 | 1 |
| | | C | 30-39 | 3 | 1 |
| | | D | 40-49 | 3 | 1 |
| | | E | 50-59 | 3 | 1 |
| | | F | More than 60 | 3 | 1 |
| 2 | What do you | A | Fear cold | 2 | 1 |
| | fear? | B | Fear heat | 4 | 1 |
| | | C | Fear cold and | 2 | 1 |
| | | | heat | | |
| | | D | Fear none | 3 | 1 |
| 3 | What | A | Impatient | 4 | 1 |
| | characteristic | B | Patient | 2 | 1 |
| | best describes | C | Between A and | 3 | 1 |
| | you? | | B | | |
| 4 | Do you often | A | Often | 5 | 2 |
| | have sweaty | B | Sometimes | 4 | 1 |
| | palms? | C | Seldom | 4 | 1 |
| | | D | Never | 3 | 1 |
| 5 | What flavors | A | Heavy | 4 | 1 |
| | do you prefer? | B | Bland | 2 | 1 |
| | | C | No preference | 3 | 1 |
| 6 | Do you have | A | Often | 5 | 1 |
| | night sweats | B | Sometimes | 4 | 1 |
| | while sleeping? | C | Seldom | 4 | 1 |
| | | D | Never | 3 | 1 |
| 7 | What is the | A | Red | 4 | 1 |
| | color of your | B | Rosy | 3 | 1 |
| | cheeks? | C | Below Rosy | 2 | 1 |
| | | D | Pale | 1 | 1 |
| | | E | Sallow | 1 | 1 |
| 8 | Skin color | A | Red | 5 | 1 |
| | variant scale | B | Rosy | 4 | 1 |
| | | C | Below Rosy | 2 | 1 |
| | | D | Pale | 1 | 1 |
| | | E | Sallow | 1 | 1 |
| 9 | How would | A | Very Dull | 1 | 3 |
| | you describe | B | Dull | 2 | 3 |
| | your overall | C | Somewhat | 3 | 3 |
| | facial | | Radiant | | |
| | complexion? | D | Radiant | 4 | 2 |
| | | E | Very Radiant | 5 | 2 |
| 10 | Dull-Radiance | A | 0 | 1 | 1 |
| | scale | B | 1 | 1 | 1 |
| | | C | 2 | 2 | 1 |
| | | D | 3 | 2 | 1 |
| | | E | 4 | 3 | 1 |
| | | F | 5 | 3 | 1 |
| | | G | 6 | 3 | 1 |
| | | H | 7 | 4 | 1 |
| | | I | 8 | 4 | 1 |
| | | J | 9 | 5 | 1 |
| | | K | 10 | 5 | 2 |
| 11 | Do you have | A | Yes | 4 | 2 |
| | facial | B | No | 3 | 1 |
| | blemishes? | | | | |
| 12 | Acne breakout | A | 0 | 3 | 1 |
| | scale | B | 1 | 4 | 1 |
| | | C | 2 | 4 | 2 |
| | | D | 3 | 4 | 2 |
| | | E | 4 | 5 | 3 |
| | | F | 5 | 5 | 3 |
| | | G | 6 | 5 | 3 |
| | | H | 7 | 5 | 3 |
| | | I | 8 | 5 | 3 |
| | | J | 9 | 5 | 3 |
| | | K | 10 | 5 | 3 |
| 13 | How | A | Once a week | 5 | 3 |
| | frequently do | | or more | | |
| | you usually | B | About once | 4 | 3 |
| | experience | | every two | | |
| | facial | | weeks | | |
| | blemishes, if at | C | At least once a | 4 | 2 |
| | all? | | month | | |
| | | D | Less than once | 3 | 2 |
| | | | a month | | |
| | | E | Never | 3 | 1 |
| 14 | What is your | A | Dry | 1 | 1 |
| | skin condition? | B | Normal to dry | 2 | 1 |
| | | C | Normal or | 3 | 1 |
| | | | balanced | | |
| | | D | Normal to oily | 4 | 1 |
| | | E | Oily | 5 | 1 |
| 15 | Dry/Moist/Oily | A | Dry | 2 | 1 |
| | scale | B | Moist | 3 | 1 |
| | | C | Oily | 4 | 1 |
| 16 | Do you have | A | Yes | 1 | 1 |
| | severely dry | B | No | 3 | 1 |
| | facial skin? | | | | |
| 17 | Do you have | A | Yes | 3 | 1 |
| | facial | B | No | 3 | 1 |
| | pigmentation | | | | |
| | issues? | | | | |
| 18 | Skin Tone | A | 0 | 3 | 1 |
| | scale | B | 1 | 3 | 1 |
| | | C | 2 | 3 | 1 |
| | | D | 3 | 3 | 1 |
| | | E | 4 | 3 | 1 |
| | | F | 5 | 3 | 2 |
| | | G | 6 | 3 | 2 |
| | | H | 7 | 3 | 2 |
| | | I | 8 | 3 | 2 |
| | | J | 9 | 3 | 2 |
| | | K | 10 | 3 | 2 |
| 19 | Do you have | A | Yes | 2 | 1 |
| | dark spots on | B | No | 3 | 1 |
| | your face? | | | | |
| 20 | Age/Dark | A | 0 | 3 | 1 |
| | Spots scale | B | 1 | 2 | 1 |
| | | C | 2 | 2 | 2 |
| | | D | 3 | 2 | 2 |
| | | E | 4 | 2 | 2 |
| | | F | 5 | 2 | 3 |
| | | G | 6 | 2 | 3 |
| | | H | 7 | 1 | 3 |
| | | I | 8 | 1 | 3 |
| | | J | 9 | 1 | 3 |
| | | K | 10 | 1 | 3 |
| 21 | If you have | A | Stress | 4 | 1 |
| | difficulty | B | Snoring | 4 | 1 |
| | staying asleep, | C | Physical | 4 | 1 |
| | for what | | discomfort | | |
| | reason is your | D | Room too | 4 | 1 |
| | sleep | | warm/cold | | |
| | disturbed? | E | Noise | 4 | 1 |
| | | F | Light | 4 | 1 |
| | | G | Smells | 4 | 1 |
| | | H | No trouble | 3 | 1 |
| | | | staying asleep | | |
| 22 | Do you have | A | Yes | 4 | 1 |
| | difficulty | B | No | 3 | 1 |
| | falling | | | | |
| | asleep? | | | | |
| 23 | How many | A | Everyday | 3 | 1 |
| | times a week | B | 5-6 days per | 3 | 1 |
| | do you | | week | | |
| | exercise? | C | 3-4 days per | 3 | 1 |
| | | | week | | |
| | | D | 1-2 days per | 3 | 1 |
| | | | week | | |
| | | E | Less often than | Average of | 1 |
| | | | once a week | questions 2-20 | |
| | | F | Never | Average of | 1 |
| | | | | questions 2-20 | |
| 24 | How | A | Everyday | 3 | 1 |
| | frequently do | B | 5-6 days per | 3 | 1 |
| | you take | | week | | |
| | vitamin | C | 3-4 days per | 3 | 1 |
| | supplements? | | week | | |
| | | D | 1-2 days per | 3 | 1 |
| | | | week | | |
| | | E | Less often than | Average of | 1 |
| | | | once a week | questions 2-20 | |
| | | F | Never | Average of | 1 |
| | | | | questions 2-20 | |
| 25 | Which of the | A | Well balanced | 3 | 1 |
| | following best | | meal | | |
| | describes your | B | Somewhat | Average of | 1 |
| | typical meal? | | balanced meal | questions 2-20 | |
| | | C | Not balanced | Average of | 1 |
| | | | meal | questions 2-20 | |
| 26 | How would | A | Excellent | 3 | 1 |
| | you rate your | B | Very good | 3 | 1 |
| | emotional | C | Good | 3 | 1 |
| | well-being? | D | Fair | Average of | 1 |
| | | | | questions 2-20 | |
| | | E | Poor | Average of | 1 |
| | | | | questions 2-20 | |

Once the subject's responses are plotted as data points on the map, the beauty consultant can click on an individual point or points (or touch a point or points on a touch screen computer) to reveal text, images, videos, and the like, which explain the significance of a question and the consumer's response to the question. Most important, the beauty consultant is able to recognize various concentrations or sub-groupings of points on the map, and analyze relationships between points in a subgroup, and/or between and among sub-groups, so as to contextualize the consumer's responses. In this way, the consultant is enabled to gain a clearer understanding of the factors contributing to a particular response and to one or more specific health/wellness concerns of the customer, and therefore a clearer overall image of the customer as an individual.

### EXAMPLES

### Example 1

A comprehensive questionnaire completed by a single respondent is provided below in Table 3. In this case, the responses were entered into a diagnostic software program on a computer, the program taking the user through a series of multiple choice questions. The program operates as follows. To select an answer, the user taps or clicks on the letter next to the answer choice. A blinking circle with an arrow appears to the right of the question and answer box. To move to the next question, the user taps or clicks on the arrow. Skipping questions is not permitted, since the arrow to the right only appears after the question has been answered. To return to a previous question, the user taps or clicks on an arrow to the left of the question and answer box. To clear answers and start the diagnostic from the beginning, the user may tap or click on the “starting over” icon at the top of the screen. A user may quit the program at any time by tapping or clicking the “quit” icon at the top of the screen. During the question portion of the diagnostic, users may view their progress by looking at the top of the screen. Also at the top of the screen is a navigation tool which shows the user all of the questions when clicked. Answered and unanswered questions are differently colored from one another. To exit that window, the use may tap or click on the “close” icon at the bottom of the screen. Once the user has completed the questions, she receives a number from 1 to 5. The user then taps or clicks on the number to move to the next screen which will provide the user with a detailed profile for her skin including a unique map with numbers posted to it. The user may tap or click on any of the numbers. Each number will bring the user to that particular number question asked in the diagnostic. Users are provided with an explanation and detailed information to educate the user on the relevance of the question and answer to their skin concern. The user may then exit the program by taping or clicking on the “quit” icon at the top of the screen.

TABLE 3
Exemplary Questionnaire

| Question | | Response | | Concentric Circles | | | |
|---|---|---|---|---|---|---|---|
| 1a | What is your age? | A | Less than | 5 concentric circles | | | |
| | | | 19 | | | | |
| | | | | Point | Line | Radial | Point |
| Question | | Response | | Color | Length | Segment | Diameter |
| 1b | What is your age? | A | Less than | 3 | 1 | 3 | 1 |
| | | | 19 | | | | |
| 2 | What do you fear? | A | Fear cold | 1 | 22 | 2 | 1 |
| 3 | What characteristic best | B | Patient | 1 | 12 | 2 | 1 |
| | describes you? | | | | | | |
| 4 | Do you often have sweaty | D | Never | 1 | 20 | 3 | 1 |
| | palms? | | | | | | |
| 5 | What flavors do you | B | Bland | 1 | 11 | 2 | 1 |
| | prefer? | | | | | | |
| 6 | Do you have night sweats | A | Often | 1 | 19 | 5 | 1 |
| | while sleeping? | | | | | | |
| 7 | What is the color of your | D | Pale | 2 | 21 | 1 | 1 |
| | cheeks? | | | | | | |
| 8 | Skin color variant scale | D | Pale | 2 | 23 | 1 | 1 |
| 9 | How would you describe | A | Very Dull | 2 | 13 | 1 | 3 |
| | your overall facial | | | | | | |
| | complexion? | | | | | | |
| 10 | Dull-Radiance scale | C | 2 | 2 | 17 | 2 | 1 |
| 11 | Do you have facial | B | No | 2 | 24 | 3 | 1 |
| | blemishes? | | | | | | |
| 12 | Acne breakout scale | A | 0 | 2 | 26 | 3 | 1 |
| 13 | How frequently do you | E | Never | 2 | 9 | 3 | 1 |
| | usually experience facial | | | | | | |
| | blemishes, if at all? | | | | | | |
| 14 | What is your skin | A | Dry | 2 | 15 | 1 | 1 |
| | condition? | | | | | | |
| 15 | Dry/Moist/Oily scale | A | Dry | 2 | 16 | 2 | 1 |
| 16 | Do you have severely dry | A | Yes | 2 | 14 | 1 | 1 |
| | facial skin? | | | | | | |
| 17 | Do you have facial | A | Yes | 2 | 7 | 3 | 1 |
| | pigmentation issues? | | | | | | |
| 18 | Skin Tone scale | D | 3 | 2 | 8 | 3 | 1 |
| 19 | Do you have dark spots on | B | No | 2 | 18 | 3 | 1 |
| | your face? | | | | | | |
| 20 | Age/Dark Spots scale | A | 0 | 2 | 25 | 3 | 1 |
| 21 | If you have difficulty | A | Stress | 3 | 10 | 4 | 1 |
| | staying asleep, for what | | | | | | |
| | reason is your sleep | | | | | | |
| | disturbed? | | | | | | |
| 22 | Do you have difficulty | A | Yes | 3 | 6 | 4 | 1 |
| | falling asleep? | | | | | | |
| 23 | How many times a week | F | Never | 3 | 3 | 2 | 1 |
| | do you exercise? | | | | | | |
| 24 | How frequently do you | F | Never | 3 | 2 | 2 | 1 |
| | take vitamin | | | | | | |
| | supplements? | | | | | | |
| 25 | Which of the following | C | Not | 3 | 5 | 2 | 1 |
| | best describes your typical | | balanced | | | | |
| | meal? | | meal | | | | |
| 26 | How would you rate your | C | Good | 3 | 4 | 3 | 1 |
| | emotional well-being? | | | | | | |

### Example 2

An example of the computer software code or logic used to map the responses provided above in Table 3 is shown below:

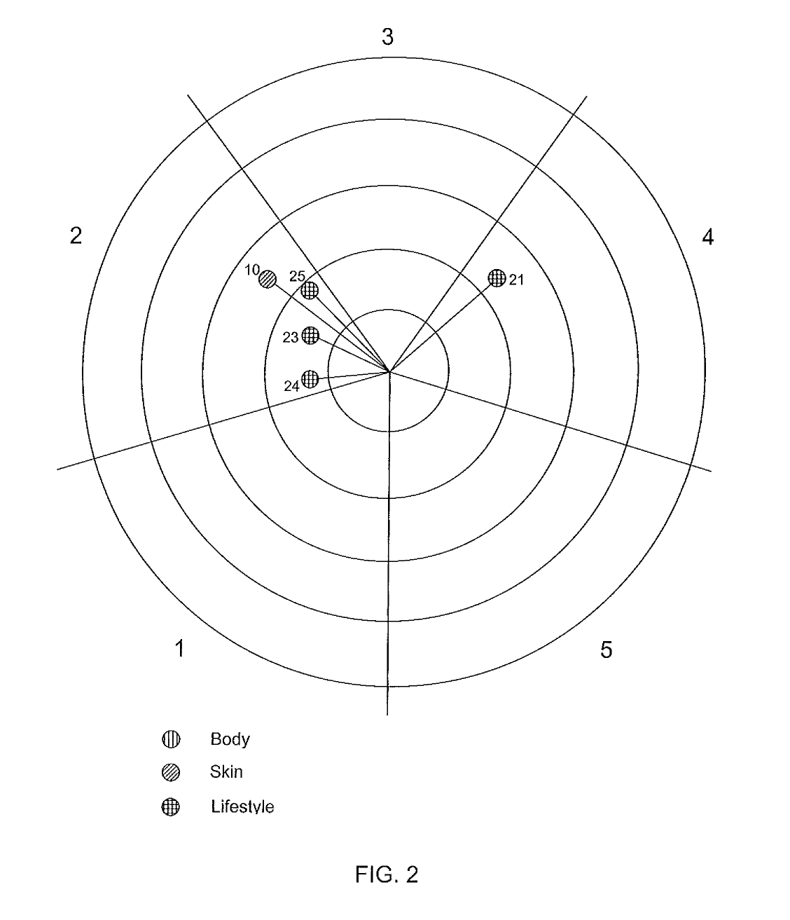

FIG. 1 is a unique visual depiction (e.g., map) of the respondent's answers, as they relate to the question-related and response-related criteria outlined above, and presented above in Table 3. The data points are spread out over all five segments of the map, mostly within segments 1, 2 and 3. Nevertheless, the map per se makes no conclusions concerning the meaning of the responses in aggregate. It is the beauty consultant who will recognize subgroups of data points (i.e., responses) and use these areas of concentration to contextualize specific responses and offer educational information and product recommendations, as illustrated below in FIG. 2.

FIG. 2 is a partial representation of plotted points shown above in FIG. 1, illustrating one particular sub-grouping or concentration of responses which may be appreciated by a beauty consultant. The subject may, but not necessarily, have communicated a concern about her lack of skin radiance to the consultant, and the consultant may then recognize and analyze one or more concentrations of data points in order to determine the relevance of these responses to the subject's concern, such as a concentration of responses to lifestyle questions as explained below. Data points representing answers corresponding to questions 10, 21, and 23-25 are shown. Data point 10 is a response to a skin question relating to the subject's self-evaluation of her skin radiance, while questions 21 and 23-25 are responses to lifestyle questions which are concentrated proximally to the response to question 10. The questions and responses are as follows:

Question 10: How radiant is your skin (on a 1-10 scale)?

Response: 2 (out of 10).

Question 21: If you are having a hard time staying asleep what do you attribute it to?

Response: Stress.

Question 23: How many times a week do you exercise?

Response: Never.

Question 24: How frequently do you take vitamin supplements?

Response: Never.

Question 25: Which of the following best describes your typical meal?

Response: Not a well-balanced meal.

Beyond the basic observation, based on the answer to question 10, that the consumer feels that her skin is not very radiant, the beauty consultant may infer, from the context provided by the answers to questions 21 and 23-25, that the consumer's dull complexion may be attributable to a number of factors, including poor sleep pattern, lack of exercise, and poor diet. Therefore, the consultant may recommend various lifestyle changes to the consumer, including that she begin a modest regimen of exercise which may improve the quality of sleep and thus reduce stress, consume vitamin/mineral supplements, and juices and/or foods rich in antioxidants along with more water, in order to improve her overall health and thereby improve skin radiance.

As a further example, the consultant may also see a concentration of data points corresponding to the answers to skin questions 7-9, 14 and 16 on the map and may also analyze their relevance to the consumer's response to question 10 regarding skin radiance.

Question 10: How radiant is your skin (on a 1-10 scale)?

Response: 2

Question 7: What is the color of your cheeks?

Response: Pale

Question 8: Skin color variant scale?

Response: Pale

Question 9: How would you describe your overall facial complexion?

Response: Very dull

Question: 14: What is your skin condition?

Response: Dry

Question 16: Do you have severely dry facial skin?

Response: Yes

As illustrated above with regard to the concentration of points 7-9, 14 and 16 on the map, in addition to using the systems and methods of the present invention to identify service opportunities, so as to educate the consumer based on inferences the consultant may make between dry, pale skin and a lack of skin radiance, the consultant also may use the present invention to identify marketing opportunities to recommend skin products which will treat the surface and upper layers of the skin to relieve dryness and regain radiance. The systems and methods of the present invention allow the consultant to click on a point (or touch the touch screen at a point) to determine the relevance of a response to one or more particular health/wellness concerns, and to educate the consumer about her specific concerns through text, images, videos and so forth. As an example, the consumer indicates, in response to question 14 (What is your skin condition?), that her skin is dry. The consultant may then click on point 14, for example, on the consumer's map and use the information in the text, images and/or videos that appear to educate the consumer on possible causes of dry skin which may contribute to a lack of radiance, including the relationships of low levels of moisture and a thinner skin moisture barrier to the development of dry skin, and to recommend a course of treatment. The treatment may include lifestyle changes, but also a product or regimen of products (e.g., skin care products, vitamins/supplements) intended to help bring about health/wellness balance, including an improvement in the skin's radiance.

As yet a further example, FIG. 1 indicates that the consumer has facial pigmentation concerns. Although this concern may not directly relate to lack of radiance, the systems and methods of the invention allow the recognition by the beauty consultant that the consumer may be a candidate for a product or product regimen which acts to even the skin tone. The consultant may click on data points 17, 18 to provide educational information regarding causes of uneven skin tone and the lifestyle and cosmetic treatments which may help to bring about a more even toned complexion.

In yet a further example, a consumer's overall skin condition may be assessed to be oily, but she may have dry skin and fine lines around her eyes. The consultant may then take the opportunity to recommend, in addition to a treatment regimen for the oily portions of the skin, an eye cream specifically for use around the eyes, thus customizing the service.

Furthermore, the systems and methods of the present invention may also be adapted to indicate whether certain products may be used with other products or whether the ingredients of a product would have a counteractive effect on the ingredients or performance of other products.

Thus, to the untrained eye, the data points on maps generated in accordance with the present invention may have no particular meaning, or at most, the data points may appear merely to fall generally within a particular segment of the map so that the subject may appear merely to fall within a particular bucket or group. However, the present invention allows a trained beauty consultant to use sub-groupings of questions and responses, such as those provided in the examples given above, in a meaningful way, by recognizing connections between responses, and cause and effect relationships, thus providing a context for a respondent's answers.

In addition to leading to a greater understanding about an individual customer, the “proximity inferences”, garnered from the contextualized responses, serve as a platform for educating a consumer with beauty and wellness information specific to the sub-groupings of her responses and further permit the identification of marketing opportunities to introduce the consumer to products and/or regimens that are specifically targeted to her on the basis of specific subgroups of her responses to questions. The invention is flexible, since, as more understanding is gained from the concerns and desires of consumers and about skin per se, the systems and methods of the invention, including software, can be tailored to identify and incorporate new questions and therefore new sub-groupings or patterns of responses that may have relevance in understanding and serving consumers.

Although described in terms of a tool useful by a beauty consultant in a retail setting, it will be understood that the systems and methods of the present invention may also be used directly by a consumer who may access the software program at a kiosk, for example in a department store, or remotely through an app on a handheld or mobile device, such as a smart phone or a tablet. When used directly by a consumer, to facilitate analysis by the consumer, the maps generated may be appended with icons, for example, to represent the relevant sub-groupings.

While the invention has been described in connection with preferred embodiments, it is not intended to limit the scope of the invention to the particular forms set forth but is intended to cover such alternatives, modifications and equivalents as may be included within the spirit and scope of the invention as defined by the appended claims. Therefore, it will be understood by those skilled in the art that the systems and methods of the present invention may be applied to any set of information collected on an individual subject which is based on a particular set of parameters which have been pre-determined to be relevant to an evaluation of a characteristic or related group of characteristics of the subject.

What is claimed is:

1. A diagnostic system comprising a set of multiple choice questions, wherein each multiple choice question has:
a category assigned thereto;
a predetermined relative importance assigned thereto;
a selection of possible responses associated therewith, each possible response having a predetermined relative importance assigned thereto; and
a graphical representation comprising a set of graphical elements drawn on a segmented plane, each graphical element corresponding to a subject's response and comprising:
a graphical indication of the category of question;
a graphical indication of the relative importance of each question;
a graphical indication of the relative importance of each response of the subject; and
a graphical indication of the relevance of each response of the subject according to a predetermined model of health and/or wellness;
said graphical representation permitting a user of the diagnostic system to utilize the relative positioning of at least one graphical element on the graphical representation to draw at least one inference relative to a health and/or wellness concern of the subject.

2. The diagnostic system of claim 1, wherein the graphical indication of the category of question is a predetermined pattern of shading.

3. The diagnostic system of claim 1, wherein the graphical indication of the relative importance of each question is a radial line segment of predetermined length.

4. The diagnostic system of claim 1, wherein the graphical indication of the relative importance of each response of the subject is a point having a diameter of predetermined length.

5. The diagnostic system of claim 1, wherein the graphical indication of the relevance of each response of the subject according to a predetermined model of health and/or wellness is a location within one segment of the segmented plane.

6. The diagnostic system of claim 1, wherein the model of health and/or wellness is based at least in part on Traditional Chinese Medicine (TCM).

7. The diagnostic system of claim 1, further comprising:
a data entry module configured for entering into the system a data set comprising responses to the set of multiple choice questions obtained from the subject;
a data processing module in communication with the data entry module, wherein the data processing module is configured for applying a software program to the data set entered through the data entry module, the data processing module containing coded instructions for processing the data set;
a display or output module in communication with the data processing module for displaying the graphical representation; and
a memory module which stores educational information in the form of text, images, and/or videos which explain the relative importance of the questions and the answers to a health and/or wellness concern of the subject.

8. The diagnostic system of claim 7, wherein the data entry module is a keyboard or a touch screen, the data processing module is a central processing unit (CPU), and the display or output module is a computer display screen, a mobile device display screen, a printer, or a network connection for outputting the graphical representation to a remote location.

9. The diagnostic system of claim 1, wherein the set of multiple choice questions relates to a skin condition of the subject.

10. The diagnostic system of claim 9, wherein the skin condition is selected from the group consisting of lack of radiance, dryness, oiliness, redness, acne, excessive pigmentation, uneven skin tone, wrinkles, sagging skin and sensitivity.

11. The diagnostic system of claim 1, wherein the category of multiple choice questions is selected from the group consisting of skin and skin care, body constitution based on TCM principles, and lifestyle.

12. The diagnostic system of claim 1, said graphical representation permitting the user to utilize the relative positioning of at least one graphical element corresponding to at least one or the subject's responses in relation to at least one other graphical element corresponding to at least one other of the subject's responses on the graphical representation to draw at least one inference relative to a health and/or wellness concern of the subject.

13. The diagnostic system of claim 1, said graphical representation permitting the user to recognize at least one subgroup of at least two graphical elements corresponding to at least two of the subject's responses and to analyze the at least two of the subject's responses in the context of a health and/or wellness concern of the subject.

14. The diagnostic system of claim 1, further comprising a graphical indication of the subject's age.

15. The diagnostic system of claim 1, wherein the user is the subject.
